(19) United States
(12) Patent Application Publication
(10) Pub. No.: US 2025/0358089 A1
(43) Pub. Date: Nov. 20, 2025

(54) FLEXIBLE DUPLEX SIGNALING FOR INDICATING DUPLEX SUPPORT

(71) Applicant: Nokia Technologies Oy, Espoo (FI)

(72) Inventors: Sari Kaarina NIELSEN, Espoo (FI); Toni Harri Henrikki LÄHTEENSUO, Helsinki (FI); Johannes HARREBEK, Aalborg (DK)

(21) Appl. No.: 19/108,566

(22) PCT Filed: Sep. 7, 2022
(86) PCT No.: PCT/FI2022/050593

§ 371 Date: Mar. 4, 2025

(51) Int. Cl. H04L 5/14

(52) U.S. Cl. CPC H04L 5/1438

(57) ABSTRACT

A method comprising, evaluating, at a terminal, an ability of the terminal to operate in flexible duplex mode based on at least one of a signal condition or an operating condition prevailing at the terminal; and providing ability information comprising information about the terminal's evaluated ability.

### TECHNICAL FIELD

The present disclosure relates to a method and an apparatus for flexible duplex signaling for indicating duplex support.

### BACKGROUND ART

The following description of background art may include insights, discoveries, understandings or disclosures, or associations, together with disclosures not known to the relevant prior art, to at least some examples of embodiments of the present disclosure but provided by the disclosure. Some of such contributions of the disclosure may be specifically pointed out below, whereas other of such contributions of the disclosure will be apparent from the related context.

In the last years, an increasing extension of communication networks, e.g. of wire based communication networks, such as the Integrated Services Digital Network (ISDN), Digital Subscriber Line (DSL), or wireless communication networks, such as the cdma2000 (code division multiple access) system, cellular 3^{rd} generation (3G) like the Universal Mobile Telecommunications System (UMTS), fourth generation (4G) communication networks or enhanced communication networks based e.g. on Long Term Evolution (LTE) or Long Term Evolution-Advanced (LTE-A), fifth generation (5G) communication networks, cellular 2^{nd} generation (2G) communication networks like the Global System for Mobile communications (GSM), the General Packet Radio System (GPRS), the Enhanced Data Rates for Global Evolution (EDGE), or other wireless communication system, such as the Wireless Local Area Network (WLAN), Bluetooth or Worldwide Interoperability for Microwave Access (WiMAX), took place all over the world. Various organizations, such as the European Telecommunications Standards Institute (ETSI), the 3^{rd} Generation Partnership Project (3GPP), Telecoms & Internet converged Services & Protocols for Advanced Networks (TISPAN), the International Telecommunication Union (ITU), 3^{rd} Generation Partnership Project 2 (3GPP2), Internet Engineering Task Force (IETF), the IEEE (Institute of Electrical and Electronics Engineers), the WiMAX Forum and the like are working on standards or specifications for telecommunication network and access environments.

In Rel-18 Study Item on evolution of New Radio (NR) duplex operation it is assumed that a gNB supports duplex enhancements and user equipments (UEs) only support half duplex initially. However, it is expected, and it was already discussed in 3GPP that it is likely that later also UEs are expected to support duplex enhancements like flexible duplex operations. Flexible duplex operations means that uplink (UL) and downlink (DL) would operate within same Time Division Duplex (TDD) carrier on non-overlapping frequency resources. It shall further be noted that TDD refers to duplex communication links where uplink is separated from downlink by the allocation of different time slots in the same frequency band. With flexible duplex, there are different non-overlapping frequency resources that could be used at the same time by e.g. the UE.

In this context, for improving understandability only, the following is to be considered in view of frequency division duplexing (FDD). Namely, in FDD there are two carriers, one for UL and one for DL. In contrast thereto, in flexible duplex mode, there is only one TDD carrier, which can have non-overlapping resources useable by the UE simultaneously in UL and DL.

Thus, in view of the above, there is need for further improvement in the field of flexible duplexing operation for UEs. It is therefore an object of the present disclosure to improve the prior art.

The following meanings for the abbreviations used in this specification apply:
2G Second Generation
3G Third Generation
3GPP 3^{rd} Generation Partnership Project
3GGP2 3^{rd} Generation Partnership Project 2
4G Fourth Generation
5G Fifth Generation
6G Sixth Generation
AMF Access and Mobility Management Function
AN Access Node
AP Access Point
BS Base Station
CDMA Code Division Multiple Access
CSI Channel State Information
DC Direct Current
DL Downlink
DSL Digital Subscriber Line
EDGE Enhanced Data Rates for Global Evolution
EEPROM Electrically Erasable Programmable Read-only Memory
eNB Evolved Node B
ETSI European Telecommunications Standards Institute
FD-SIC Flexible Duplexing Self Interference Cancellation
FDD Frequency Division Duplexing
gNB Next Generation Node B
GPRS General Packet Radio System
GSM Global System for Mobile communications
IEEE Institute of Electrical and Electronics Engineers
IQ In-Phase and Quadrature
ISDN Integrated Services Digital Network
ITU International Telecommunication Union
LTE Long Term Evolution
LTE-A Long Term Evolution-Advanced
MANETs Mobile Ad-Hoc Networks
MAC Medium Access Control
MAC-CE MAC Control Element
MCS Modulation and Coding Scheme
NB Node B
NR New Radio
PRB Physical Resource Block
RAM Random Access Memory
RAN Radio Access Network
RB Resource Block
ROM Read Only Memory
RRC Radio Resource Control
Rx Receiver
Subcarrier Spacing SCS
SINR Signal to Interference and Noise Ratio
SMF Session Management Function
TISPAN Telecoms & Internet converged Services & Protocols for Advanced Networks
TDD Time Division Duplex
Tx Transmitter/transmit
UE User Equipment
UL Uplink
UMTS Universal Mobile Telecommunications System
UWB Ultra-Wideband
WCDMA Wideband Code Division Multiple Access
WiMAX Worldwide Interoperability for Microwave Access
WLAN Wireless Local Area Network

### SUMMARY

It is an objective of various examples of embodiments of the present disclosure to improve the prior art. Hence, at least some examples of embodiments of the present disclosure aim at addressing at least part of the above issues and/or problems and drawbacks.

Various aspects of examples of embodiments of the present disclosure are set out in the appended claims and relate to methods, apparatuses and computer program products relating to flexible duplex signaling for indicating duplex support.

The objective is achieved by the methods, apparatuses and non-transitory storage media as specified in the appended claims. Advantageous further developments are set out in respective dependent claims.

Any one of the aspects mentioned according to the appended claims enables flexible duplex signaling for indicating duplex support, thereby allowing to solve at least part of the problems and drawbacks as identified/derivable from above.

Thus, improvement is achieved by methods, apparatuses and computer program products enabling flexible duplex signaling for indicating duplex support.

### BRIEF DESCRIPTION OF THE DRAWINGS

Some embodiments of the present disclosure are described below, by way of example only, with reference to the accompanying drawings, in which:

FIG. 1 shows levels at a UE relative to the UE's distance from a gNB;

FIG. 2 shows a signaling flow for a dynamic flexible duplex indication, according to various examples of embodiments;

FIG. 3 shows a signaling flow for a dynamic flexible duplex indication, according to various examples of embodiments;

FIG. 4 shows a flowchart illustrating steps corresponding to a method according to various examples of embodiments;

FIG. 5 shows a flowchart illustrating steps corresponding to a method according to various examples of embodiments;

FIG. 6 shows a block diagram illustrating an apparatus according to various examples of embodiments;

FIG. 7 shows a block diagram illustrating an apparatus according to various examples of embodiments; and

FIG. 8 shows a diagram illustrating signaling flows according to various examples of embodiments.

### DESCRIPTION OF EMBODIMENTS

Basically, for properly establishing and handling a communication between two or more end points (e.g. communication stations or elements or functions, such as terminal devices, user equipments (UEs), or other communication network elements, a database, a server, host etc.), one or more network elements or functions (e.g. virtualized network functions), such as communication network control elements or functions, for example access network elements like access points (APs), radio base stations (BSs), relay stations, eNBs, gNBs etc., and core network elements or functions, for example control nodes, support nodes, service nodes, gateways, user plane functions, access and mobility functions etc., may be involved, which may belong to one communication network system or different communication network systems.

In the following, different exemplifying embodiments will be described using, as an example of a communication network to which examples of embodiments may be applied, a communication network architecture based on 3GPP standards for a communication network, such as a 5G/NR (or 6G), without restricting the embodiments to such an architecture, however. It is obvious for a person skilled in the art that the embodiments may also be applied to other kinds of communication networks like 4G and/or LTE (and even 6G) where mobile communication principles are integrated, e.g. Wi-Fi, worldwide interoperability for microwave access (WiMAX), Bluetooth®, personal communications services (PCS), ZigBee®, wideband code division multiple access (WCDMA), systems using ultra-wideband (UWB) technology, mobile ad-hoc networks (MANETs), wired access, etc., Furthermore, without loss of generality, the description of some examples of embodiments is related to a mobile communication network, but principles of the disclosure can be extended and applied to any other type of communication network, such as a wired communication network or datacenter networking.

The following examples and embodiments are to be understood only as illustrative examples. Although the specification may refer to “an”, “one”, or “some” example(s) or embodiment(s) in several locations, this does not necessarily mean that each such reference is related to the same example(s) or embodiment(s), or that the feature only applies to a single example or embodiment. Single features of different embodiments may also be combined to provide other embodiments. Furthermore, terms like “comprising” and “including” should be understood as not limiting the described embodiments to consist of only those features that have been mentioned; such examples and embodiments may also contain features, structures, units, modules etc. that have not been specifically mentioned.

A basic system architecture of a (tele) communication network including a mobile communication system where some examples of embodiments are applicable may include an architecture of one or more communication networks including wireless access network subsystem(s) and core network(s). Such an architecture may include one or more communication network control elements or functions, access network elements, radio access network elements, access service network gateways or base transceiver stations, such as a base station (BS), an access point (AP), a NodeB (NB), an eNB or a gNB, a distributed or a centralized unit (CU), which controls a respective coverage area or cell(s) and with which one or more communication stations such as communication elements or functions, like user devices (e.g. customer devices), mobile devices, or terminal devices, like a UE, or another device having a similar function, such as a modem chipset, a chip, a module etc., which can also be part of a station, an element, a function or an application capable of conducting a communication, such as a UE, an element or function usable in a machine-to-machine communication architecture, or attached as a separate element to such an element, function or application capable of conducting a communication, or the like, are capable to communicate via one or more channels via one or more communication beams for transmitting several types of data in a plurality of access domains. Furthermore, (core) network elements or network functions ((core) network control elements or network functions, (core) network management elements or network functions), such as gateway network elements/functions, mobility management entities, a mobile switching center, servers, databases and the like may be included.

The general functions and interconnections of the described elements and functions, which also depend on the actual network type, are known to those skilled in the art and described in corresponding specifications, so that a detailed description thereof is omitted herein. However, it is to be noted that several additional network elements and signaling links may be employed for a communication to or from an element, function or application, like a communication endpoint, a communication network control element, such as a server, a gateway, a radio network controller, and other elements of the same or other communication networks besides those described in detail herein below.

A communication network architecture as being considered in examples of embodiments may also be able to communicate with other networks, such as a public switched telephone network or the Internet. The communication network may also be able to support the usage of cloud services for virtual network elements or functions thereof, wherein it is to be noted that the virtual network part of the telecommunication network can also be provided by non-cloud resources, e.g. an internal network or the like. It should be appreciated that network elements of an access system, of a core network etc., and/or respective functionalities may be implemented by using any node, host, server, access node or entity etc. being suitable for such a usage. Generally, a network function can be implemented either as a network element on a dedicated hardware, as a software instance running on a dedicated hardware, or as a virtualized function instantiated on an appropriate platform, e.g., a cloud infrastructure.

Furthermore, a network element, such as communication elements, like a UE, a mobile device, a terminal device, an endpoint terminal, a terminal, control elements or functions, such as access network elements, like a base station (BS), an eNB/gNB, a radio network controller, a core network control element or function, such as a gateway element, or other network elements or functions, as described herein, (core) network management element or function and any other elements, functions or applications may be implemented by software, e.g. by a computer program product for a computer, and/or by hardware. For executing their respective processing, correspondingly used devices, nodes, functions or network elements may include several means, modules, units, components, etc. (not shown) which are required for control, processing and/or communication/signaling functionality. Such means, modules, units and components may include, for example, one or more processors or processor units including one or more processing portions for executing instructions and/or programs and/or for processing data, storage or memory units or means for storing instructions, programs and/or data, for serving as a work area of the processor or processing portion and the like (e.g. ROM, RAM, EEPROM, and the like), input or interface means for inputting data and instructions by software (e.g. floppy disc, CD-ROM, EEPROM, and the like), a user interface for providing monitor and manipulation possibilities to a user (e.g. a screen, a keyboard and the like), other interface or means for establishing links and/or connections under the control of the processor unit or portion (e.g. wired and wireless interface means, radio interface means including e.g. an antenna unit or the like, means for forming a radio communication part etc.) and the like, wherein respective means forming an interface, such as a radio communication part, can be also located on a remote site (e.g. a radio head or a radio station etc.). It is to be noted that in the present specification processing portions should not be only considered to represent physical portions of one or more processors, but may also be considered as a logical division of the referred processing tasks performed by one or more processors.

It should be appreciated that according to some examples, a so-called “liquid” or flexible network concept may be employed where the operations and functionalities of a network element, a network function, or of another entity of the network, may be performed in different entities or functions, such as in a node, host or server, in a flexible manner. In other words, a “division of labor” between involved network elements, functions or entities may vary case by case.

With regard to the present specification, there is disclosed a solution for enabling flexible duplexing operation for UEs, which is advantageous over a prior art solution for the reasons as outlined below.

Namely, UE's performance in flexible duplex operation depends at least on one of the following factors:
a UE uplink (UL) Transmitter (Tx) power level, which can refer to either the power level set by power control or the real radiated output power which depends also on external factors, like e.g. antenna load;
a UE uplink (UL) Resource Block (RB) allocation size;
a frequency offset between uplink (UL) and downlink (DL) Resource Blocks (RBs);
a downlink (DL) signal power level;
other more static emissions including emissions caused by In-Phase and Quadrature (IQ)—imbalance, direct current (DC) leakage; and
a UE's ability to cancel and/or tolerate self-interference.

As many of the above-mentioned factors vary depending on deployment scenario (e.g. macro vs small cell), data traffic amount and whether a UE is in cell center or cell edge, static minimum UE performance requirements are not sufficient to describe UE performance and what a UE can be scheduled with in live network conditions. This is because the signal conditions and a UE's implementation aspects and abilities at the UE at a given time and in given conditions are only known by the UE, and are practically always different from conditions where minimum performance requirements are defined. Therefore, using minimum performance requirements as a guideline on how to schedule the UE leads to non-optimal outcome as the network would need to make more pessimistic assumptions of the UE's flexible duplex operation capabilities.

Therefore, a dynamic indication of a UE's current practical abilities to the network would be beneficial to let the network know when and with what assumptions the UE can support flexible duplexing in current signal conditions. This will help achieving better flexible duplexing performance without too complex and costly UE and network implementations.

In the prior art, there are provided static solutions and capabilities based on minimum UE requirements and UE capability indications/signaling. For example, one solution relies on the idea that, if the gNB knows about or the UE can report its Flexible Duplexing Self Interference Cancellation (FD-SIC) capability and limitations, it can dynamically configure for flexible Duplex scheduling whenever the UE is or has reported to be within its capability bounds.

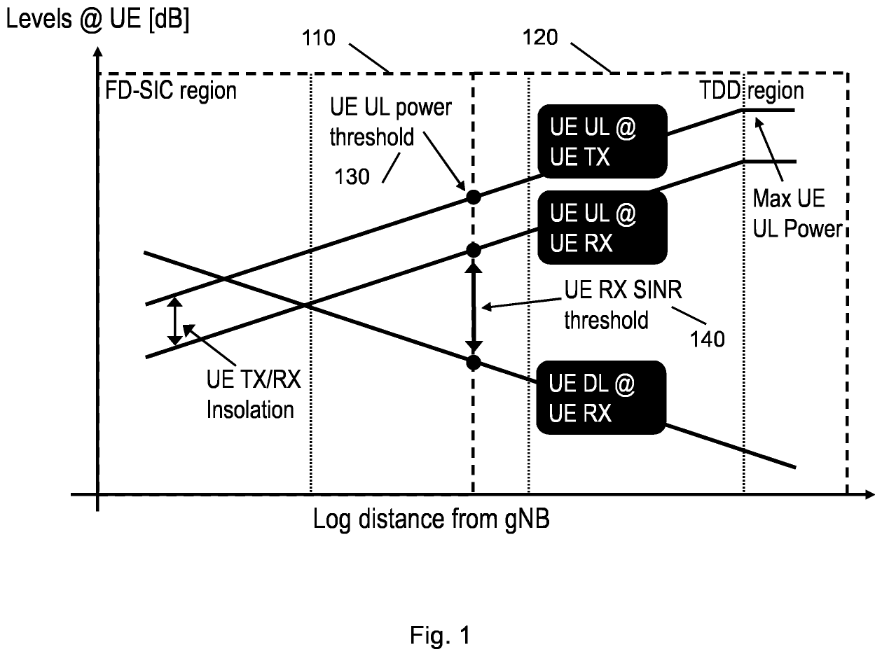

With reference to FIG. 1, levels are shown at a UE relative to the UE's distance from a gNB. In particular, FIG. 1 basically shows two regions, a FD-SIC region 110 existing in a shorter distance from the gNB and a TDD region 120 existing in a longer distance from the gNB. Accordingly, in the depicted scenario, a UE (if FD-SIC capable) may be scheduled for FD-SIC operation whenever the distance to gNB is low enough for the UE UL power (wherein a UE UL power threshold 130 is illustrated at a border section between the FD-SIC region 110 and the TDD region 120) and/or the UE Receiver (Rx) Signal to Interference and Noise Ratio (SINR) to be within its UE specific threshold limits (wherein a UE Rx SINR threshold 140 is illustrated at a border section between the FD-SIC region 110 and the TDD region 120). Further out towards a cell edge, the UE cannot guarantee adequate interference cancellation by SIC and the gNB must resume legacy TDD UE scheduling.

Prior art solutions do not provide sufficient information for the network to decide on feasible flexible duplex configurations and to make scheduling decisions for given UE while taking into account a UE's actual performance in flexible duplex mode and in the current conditions. Rather, the UE only indicates whether the UE is able to support flexible duplex operations taking into account its practical flexible duplex ability at the present scheduling configuration but does not provide information to the network about what kind of flexible duplex configurations and scheduling decisions the UE is able to support. Prior art solutions mainly rely on a UE's capabilities and a UE's measurement reports, like e.g. event-triggered measurement reports using existing UE measurement reports like UE SINR and UE Tx power measurements and measurements reports.

In the present specification, however, additional performance benefits for flexible duplex operations are achieved by a UE evaluating its actual ability to operate in flexible duplex mode with different flexible duplex parameters, while taking into account current, i.e. prevailing radio conditions, the flexible duplex parameters comprising at least one of: the UE's Tx power, the actual UE receiver performance like demodulation performance, the UE's actual self-interference mitigation performance or the UE's tolerance to self-interference. Additional performance benefits for flexible duplex operations are further achieved by the UE then indicating to the network what kind of flexible duplex configuration(s) and scheduling decisions, if any, it can support in given conditions. It should further be understood that the UE may also inform the network, if it (i.e. the UE) cannot support flexible duplex operation(s) in current (i.e. prevailing) conditions and configurations. Based on such information about such support currently not being able, the network may note that it (i.e. the network) may need to allow the given UE to operate e.g. in half-duplex mode. These indications, provided information, and/or communication between the UE and the network enables the network to decide what kind of flexible duplex parameters (like e.g. UL RB allocation size, frequency offset between DL and UL RBs) and scheduling decisions it can use for given UE while ensuring successful operations.

According to at least some examples of embodiments, one idea underlying the present specification is that UE (regularly) evaluates and signals to network information of whether or not the current, i.e. prevailing signal and operating conditions enable the UE to use flexible duplex operations and what key flexible duplex parameters can be used when the network configures flexible duplex operations for the UE and uses flexible duplex operations in its scheduling decisions. In this context, it shall be noted that the UE's signaling may be optimized such that the information about the evaluating is only signaled from the UE to the network when necessary, e.g. when a predefined condition(s) is met. While the UE may regularly, like e.g. continuously or frequently, evaluate (prevailing signal and operating) conditions, the signaling to the network may not happen after every evaluation. Rather, the signaling may e.g. happen only when there is a reason to signal information (i.e. information about the evaluating) to the network so that the signaling can be optimized. Such reason may be given in case a predefined condition(s) being met. Further, such predefined condition may represent a (sufficient) change in the prevailing signal and operating conditions from previously prevailing signal and operating conditions (i.e. the prevailing signal and operating conditions are different from signal and operating conditions prevailing at a previously performed evaluation to such an extent, that a signaling to the network is triggered). In this regard, the (sufficient) change may represent such change, that the UE now supports additional and/or less flexible duplex operations as compared to the previously performed evaluation.

According to various examples of embodiments, the UE evaluates its actual ability to operate in flexible duplex mode with different flexible duplex parameters while taking into account current radio conditions, its Tx power, the actual UE receiver performance like demodulation performance, the UE's actual self-interference mitigation performance and/or tolerance to self-interference. After the evaluation, the UE indicates to the network what kind of flexible duplex configuration(s) and scheduling decisions it can support in given conditions. However, it should further be noted that if there is no need that any (flexible duplex) parameters and/or any scheduling may be changed, signaling may be optimized in that the UE may not indicate anything to the network. Accordingly, the network may e.g. assume that the conditions have not changed (e.g. have not changed sufficiently as indicated above) and that UE can support the same parameters and/or scheduling like UL PRB allocation as before. Hence, this enables the network to decide what kind of flexible duplex parameters (like e.g. UL RB allocation size, frequency offset between DL and UL RBs) and scheduling decisions it can use for a given UE while ensuring successful operations. With further regard to the scheduling decision, it shall be noted for reasons of understandability that in scheduling decisions the network decides what configurations (like UL/DL configurations and/or slot format, etc.) to use and/or further decides about amount data/bit, resource block allocation size, and/or where these resource blocks are transmitted in time and frequency.

Moreover, according to various examples of embodiments, a set of key parameters and configurations can be abstracted so that only one index value or few indices are reported, and those indices reflect multiple parameters, configurations and/or scheduling assumptions that a given UE can currently support for its flexible duplex operations. Moreover, the signaling may be even further optimized in that only an index to a table is signaled for the UE to indicate what flexible duplex operations the UE may support. Still further, according to various examples of embodiments, the signaling from the UE to the network may be even further optimized in that the UE only sends the information like one index value, when (the prevailing signal and operating) conditions change (or have changed (sufficiently)) and/or a certain trigger condition(s) is met. This further improved signaling from the UE may be achieved by the UE using e.g. aperiodic reporting and/or event-trigger reporting mechanisms.

Alternative and/or additionally to the above-outlined reporting of the index value, according to various examples of embodiments, the UE may of course signal directly all these key parameters (in the set of key parameters) and configurations like UE Tx power, UL RB allocation size and frequency offset between DL and UL RB to the network. In an embodiment, a given index corresponds to a given set of parameters, which is indicative of UE's ability to perform flexible duplexing, e.g. the index indicates to the network the scheduling operations applicable to or supported by the UE. In this regard, the index may further indicate what configuration(s) and (flexible duplex) parameters are possible for the UE to support for flexible duplex operations in given (e.g. prevailing) conditions. The UE can also use the same reporting/indication mechanism to indicate to the network if it cannot support flexible duplex operations in current, i.e. prevailing conditions. The UE is then expected to operate successfully using flexible duplexing in conditions reflected by the reported index and all more UE-friendly signal conditions. Hence, alternatively and/or additionally, the index may also indicate that the UE cannot support flexible duplex operations in current (i.e. prevailing) conditions (like e.g. shown as an example in the below-outlined tables).

Therefore, according to at least some examples of embodiments, the UE reports its flexible duplex operational abilities in the current signal conditions assuming the UE's real performance in the field. This results in the advantage of improved flexible duplex configuration and scheduling decisions by the network as the network does not only need to use the minimum performance requirements defined by RAN4 for estimating a UE's performance. Rather, the UE's own estimation and indication of its flexible duplex support and performance in given conditions is advantageous as it is more accurate than if the network would try to estimate the UE's flexible duplex support using general UE measurement reports, UE minimum requirements and UE capability indications, like e.g. for its capability for FD self-interference mitigation. Due to different implementations, different UEs perform differently on the field and typically better than required by the minimum requirements specified by 3GPP RAN4.

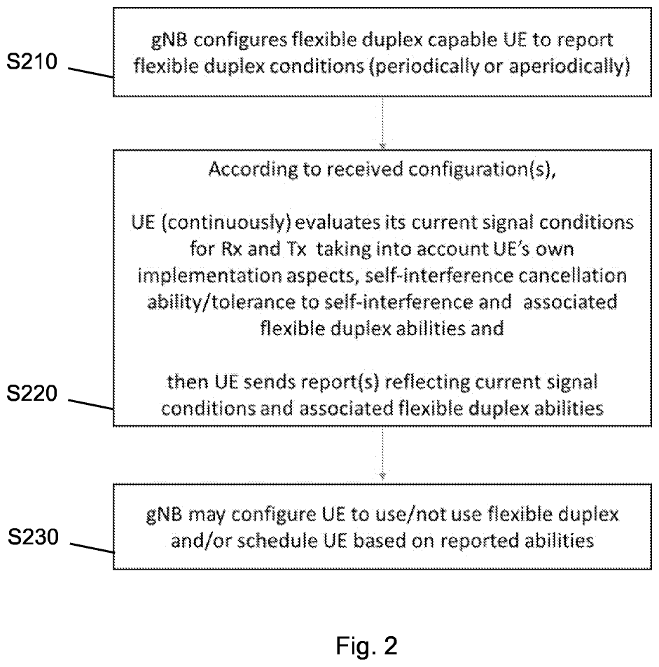

According to various examples of embodiments, selected steps according to the solution as provided herewith, with reference to FIG. 2, in order to solve the above-identified and outlined technical problem are the following, schematically illustrated for improving understandability without restricting the subject matter as derivable from the present application:
Step 210, at the gNB, directed to the UE: the gNB configures flexible duplex, enabling the UE to report flexible duplex conditions, wherein the gNB configures the flexible duplex periodically or aperiodically.
Step 220, at the UE, directed to the gNB: according to the configuration received from the gNB, the UE evaluates and sends report(s) reflecting current, i.e. prevailing signal conditions and associated flexible duplex abilities.
Step S230, at the gNB, directed to the UE: the gNB may configure the UE to use/not use flexible duplex and/or may schedule the UE based on reported abilities.

According to at least some examples of embodiments, information about a UE's ability to tolerate self-interference for flexible duplex (i.e. full duplex operations on non-overlapping frequency sub-bands) is provided through dynamic signaling from the UE to the network (e.g. to a gNB). The UE's ability to operate and perform in flexible duplex mode is defined e.g. as a combination of UE's transmit power level and how much guard band in terms of frequency (e.g. PRBs) is needed between UL and DL signal. Alternatively or additionally, the usable RBs can be reported. This information is conveyed via related fast Layer 1, L1, signaling or Medium Access Control (MAC) signaling from the UE to the network so that the network is able to allocate right resources for the UE and make correct scheduling decisions based on UE's real performance during flexible duplex operations, not only based on static minimum requirements. In view thereof, it should be noted that static minimum requirements could define that in given (e.g. prevailing) radio and interference conditions, the UE has to be able to support flexible duplex operations if, for instance, its UE TX power is below 3 dBm, its Frequency offset between DL and UL RBs for current SCS is higher than 12 PRBs and/or its UL RB allocation size is not more than 5 PRBs. However, when the UE performs better than such static minimum requirements, the UE could signal to the network that in the current, i.e. prevailing signal and interference conditions it can support flexible duplex operations when its Tx power is e.g. below 9 dBm, its Frequency offset between DL and UL RBs for current SCS is e.g. higher than 4 PRBs and/or its UL RB allocation size is e.g. not more than 15 PRBs. Hence, this means that the UE may support flexible duplex operations in more demanding conditions and more widely with higher data rates and higher transmit power, which means larger coverage areas.

According to various examples of embodiments, an UE's ability to operate in flexible duplex that can be abstracted by the dynamic L1 signaling or MAC signaling may be covered/represented by respective key parameters and/or information. Such key parameter and/or information may include at least one of the following:
Namely, the respective key parameters and/or information may include whether or not a UE is able to perform self-interference cancellation or to tolerate self-interference at certain PRBs offset from the current, i.e. prevailing UL transmission when the UE's transmit power is below a certain level.
An indication of UE's transmit power.
An indication of how much guard band in terms of frequency (e.g. PRBs) is needed between UL and DL signal.
Further, since an UL RB allocation size impacts on the amount of DL interference, the UL RB allocation size associated with a UE may be included in such respective key parameters and/or information.
Moreover, such respective key parameters and/or information may include a need for changing DL Modulation and Coding Scheme (MCS) due to flexible duplex operations: The UL to DL interference increases when flexible duplex is used and therefore there may be need to change DL MCS when starting flexible duplex operations. Normally, a UE indicates to the network what DL MCS it can support through Channel State Information (CSI) reports. Dynamic flexible duplex signaling could include additional need for changing DL MCS (e.g. delta to the current DL MCS) if/when flexible duplex operations are started in the UE. Alternatively, the dynamic UE signaling for indicating the UE's support for flexible duplex operation can be done on the basis that current downlink MCS is maintained. In either of the cases, a need for any further changes in DL MCS can be indicated from the UE to the network through regular CSI reports.

According to at least some examples of embodiments, a table of the requirements may be created as a combination of the key parameters, indicating the parameter space for which flexible duplex operations are possible. Moreover, UE demodulation requirements and test cases could be defined for given conditions to ensure that a UE performs as it reported. Furthermore, L1 signaling from the UE to the network may be defined to indicate the UE's abilities aligned with the table structure and utilizing the table information. It shall be noted that the UE may perform better than the minimum requirements, thereby e.g. enabling high data rates in scheduling. Thus, the UE may indicate support for more demanding case than the minimum requirements defined. Still further, when the UE performance may be better than the minimum requirements, the UE may inform by using L1 based or MAC based dynamic signaling, when the UE may be able to support flexible/full duplex and with what assumptions.

Table 1 presents an example according to at least some examples of embodiments of how UE dynamic signaling (e.g. L1 based or MAC based) may be defined for the UE to indicate its flexible duplex support to the network. Tables may be Subcarrier spacing (SCS)-specific in specifications, but signaling format may stay the same and refer to the currently used SCS. Additionally, to optimize signaling and signaling overhead, the signaling may be defined in such a way, that e.g. if a UE indicates a certain flexible duplex index, such signaling may mean that the UE also supports all the lower flexible duplex indexes in the table.

According to at least some examples of embodiments, dynamic signaling using flexible duplex indexes as shown in Table 1 may be sent from the UE to the network e.g., using either L1 reporting defined in the RAN1 specifications or MAC-CE based reporting defined in TS38.321 e.g., as follows:
Alternative 1: L1-report similar to channel quality indicator (CQI) reporting for the UE to indicate a flexible duplex index based on the UE's flexible duplex support in given, i.e. prevailing conditions. A periodic or aperiodic reporting of the UE may be configured.
Alternative 2: A MAC-CE reporting e.g., similar to Power Headroom Reporting with suitable triggering conditions for sending a report i.e., reporting a flexible duplex index based on a UE's flexible duplex support in given, i.e. prevailing conditions. Such report may be triggered if e.g. a UE's Tx power has changed more than a certain value, or an UL RB allocation size or frequency offset changes. Further, periodical report could be triggered if a periodic timer or a prohibit timer expires. Additionally, a change in a UE internal conditions (e.g. temperature and/or battery level, etc.) may impact UE processing capabilities and therefore trigger a report.
Alternative 3: If somewhat longer reporting delays are acceptable, also Radio Resource Control (RRC) signaling based on an event-triggered or periodical UE reporting may also be used for reporting one or more flexible duplex indexes from the UE to the network (e.g. a gNB). However, longer delays with RRC than with L1 or MAC-CE based signaling may be considered.
Alternative 4: UE may also signal directly to the network a configuration(s) and parameters it supports for flexible duplex operations, like e.g. the maximum Tx power it can support for flexible duplex operations with minimum Frequency offset between DL and UL RBs for current SCS in [Number of PRBs in below-outlined tables] and maximum UL RB allocation size in [number of PRBs in below-outlined tables] that UE can support for flexible duplex operations. It shall be noted that also directly signaling of what configuration(s) and parameters the UE supports for flexible duplex operations in given (e.g. prevailing) conditions is also possible although rather potentially not a likely signaling scheme, as it requires more bits for signaling. However, such Alternative 4 may describe the intent of the UE's signaling to the network more intensely from a UE's perspective. The other Alternatives 1 to 3 may then be more optimized from a signaling overhead perspective.

TABLE 1
Example of proposed flexible duplex index reporting table,
according to at least some examples of embodiments.

| | | | UL RB allocation size |
|---|---|---|---|
| Flexible | Tx power when flexible | Frequency offset between DL | or Maximum UL RB |
| duplex | duplex operations are | and UL RBs for current SCS | allocation size |
| index | possible [dBm] | [Number of PRBs] | [number of PRBs] |
| 0 | Flexible/Full duplex not possible | | |
| 1 | Less than (or equal to) 0 | More or at least 16 | 1 |
| 2 | Less than (or equal to) 3 | More or at least 12 | 5 |
| 3 | Less than (or equal | More or at least 8 | 10 |
| | to)<6 | | |
| 4 | Less than (or equal | More or at least 4 | 15 |
| | to)<9 | | |
| 5 | Less than (or equal | More or at least 1 | 20 |
| | to)<12 | | |
| 6 | . . . | . . . | . . . |

As exemplified in Table 2, according to various examples of embodiments, dynamic signaling indication of a UE's flexible duplex support and thus indexes may also be a combination of more than one table and, thus, more than one index to allow more independence for the parameters, e.g. a separate index for narrow and wide RB allocation, respectively.

TABLE 2
(i.e. parts 2a and 2b): Example of proposed flexible indexes reporting
tables, according to at least some examples of embodiments.
(part 2a)

| | | Frequency offset | RB allocation size or |
|---|---|---|---|
| Flexible | Tx power when flexible | between DL and UL RBs | Maximum UL RB |
| duplex | duplex operations are | for currently used SCS | allocation size |
| index1 | possible [dBm] | [Number of PRBs] | [number of PRBs] |
| 0 | Flexible/Full duplex not possible | | |
| 1 | Less than (or equal to) 0 | More or at least 16 | Less than (or equal to) 50 |
| 2 | Less than (or equal to) 3 | More or at least 12 | Less than (or equal to) 50 |
| 3 | Less than (or equal to) 6 | More or at least 8 | Less than (or equal to) 50 |
| 4 | Less than (or equal to) 9 | More or at least 4 | Less than (or equal to) 50 |
| . . . | Less than (or equal to) 12 | More or at least 1 | Less than (or equal to) 50 |

(part 2b)

| | | Frequency offset | RB allocation size or |
|---|---|---|---|
| Flexible | Tx power when flexible | between DL and UL RPs | Maximum UL RB |
| duplex | duplex operations are | for currently used SCS | allocation size |
| index2 | possible [dBm] | [Number of PRBs] | [number of PRBs] |
| 0 | Flexible/Full duplex not possible | | |
| 1 | Less than (or equal to)10 | More or at least 16 | Less than (or equal to) 5 |
| 2 | Less than (or equal to) 13 | More or at least 12 | Less than (or equal to) 5 |
| 3 | Less than (or equal to) 16 | More or at least 8 | Less than (or equal to) 5 |
| 4 | Less than (or equal to) 19 | More or at least 4 | Less than (or equal to) 5 |
| . . . | Less than (or equal to) 22 | More or at least 1 | Less than (or equal to) 5 |

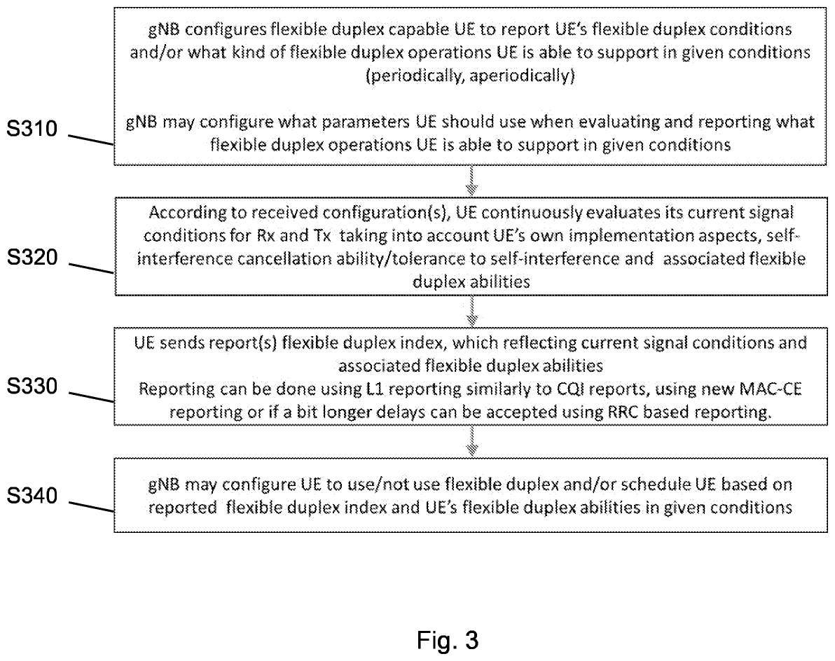

According to various examples of embodiments, a flow chart of the signaling flow as disclosed herein is shown in FIG. 3. The flow chart according to FIG. 3 is similar to the flow chart according to FIG. 2 and varies in the following aspects. Namely, in Step S310, the UE may be further configured to additionally and/or alternatively report what kind of flexible duplex operations the UE is able to support in given, i.e. prevailing conditions. The UE may perform such additional and/or alternative reporting periodically or aperiodically. In this regard, the gNB may configure the UE for such periodical or aperiodical reporting. It shall be noted, however, that the UE does not necessarily rely on receiving such configurations from the gNB. Rather, any other network entity able to communicate with the UE, e.g. a network management entity, may be enabled to provide the UE with such configurations.

Moreover, according to various examples of embodiments, in Step S310, the gNB may further configure what parameters the UE should use when evaluating and reporting what flexible duplex operations the UE is able to support in given, i.e. prevailing conditions. Such parameters may e.g. comprise a selection from the above-outlined key parameters and/or may represent the above-outlined key parameters. Hence, such parameters comprise at least one of the following: UE transmit power level, frequency offset between downlink and uplink resource blocks, UE ability to cancel or cope with self-interference, UL RB allocation size. Accordingly, in other words, it may be understood that the (prevailing) configuration from network gives (e.g. determines) these parameters, which may basically be understood to indicate to the UE what to evaluate. Accordingly, the UE may perform the evaluation, based on the received configuration including the parameters configured, i.e. selected and/or determined by the gNB. However, the UE may not necessarily rely on the parameters to be provided by the gNB. Rather, the UE may acquire a set of parameters to be considered by a network management entity or may rely on a set of parameters, which are e.g. preselected by a user.

Additionally and/or alternatively, it should be noted that at least one of the above-mentioned parameters to be used by the UE may not necessarily be configured by the gNB, but may be (directly) defined in the specification. Hence, parameters not (directly) defined in the specification may be indicated by the network to the UE, e.g. by the gNB configuring these parameters as outlined above. In view thereof, such case should also be understood as being covered according to various examples of embodiments, where (all) the rules and parameters (to be used by the UE) for such above-outlined evaluations and reporting may directly be specified and fixed in the specifications together with signaling tables. Instead of all the parameters being defined in the specification, however, the network, like e.g. the gNB (and/or a network management (core) entity) may indicate at least one parameter to be evaluated (i.e. to be used by the UE for the evaluating) and the specification may define that the UE needs to consider at least one certain (additional) parameter like e.g. the UE's ability to cancel or cope with self-interference, since the ability to cancel or cope with self-interference may be UE implementation specific. The UE minimum requirements may define how much the UE has to be able to cancel or cope with self-interference in given conditions. Hence, it may be understood that the UE may obtain at least one of the above-mentioned parameters by acquiring such parameter(s) based on its (i.e. the UE's) specific implementation and/or 3GPP specification(s) e.g. in terms of minimum UE requirements. In such case, it may be understood that the UE acquires such parameter(s) from e.g. the UE itself, since the UE itself knows about its specific implementation and/or specification.

Furthermore, according to FIG. 3, the evaluating and the reporting of an evaluation result are divided upon two steps, S320 and S330. I.e. such two processing steps of evaluating and reporting may not necessarily be performed as representing one processing step, but may be performed separated from each other, e.g. by separate processing entities. For example, it may be considered a group of at least two UEs, where one UE performs the evaluation and the at least other one UE performs the reporting, thereby reporting a configuration(s) suitable for all the UEs in the group, hence allowing to reduce communications among a gNB and UEs even further.

Step S340 outlines in more detail that the configuration and/or the scheduling of the UE may further be based on the reported at least one flexible duplex index.

It shall further be noted that before entering a flexible duplex operation, a UE cannot directly evaluate its actual flexible duplex performance but may evaluate and report its expected performance based on the present TDD configuration and operating conditions. In this case, the UE's mapping between a present TDD operation and an expected flexible duplex operation may be based on the UE's characterization and/or learning from previous (successful) flexible duplex operations at similar conditions. To prevent a link quality to be impacted by a poor TDD/flexible duplex mapping, the initial UE report may be set on the conservative side (or the network may “buffer” the reported capability) in order to be updated (soon) after entering actual flexible duplex operation.

Hence, at least some of the above-outlined various examples of embodiments provide at least some of the following advantages:
A UE's real ability to support flexible duplex (FD) operations in given, i.e. prevailing conditions instead of needing to only assume the UE's ability and performance based on the flexible duplex related UE minimum requirements (which are expected to be specified by RAN4, when the UE support for flexible duplex operations is introduced in 3GPP). This enables higher data rates for flexible duplex operations and more flexibility for network scheduling decisions with FD.
A UE directly evaluates and then indicates to the network when the UE can support flexible duplex operations and/or with what parameters and/or configurations. The network does not need to do any additional estimations if the given UE is able to support FD operations in current conditions.
Then, the network can directly utilize these UE indications (i.e. UE reports) to decide about flexible duplex configuration and scheduling decision (in relation to the UE) instead of needing to do further estimation of UE's FD ability and performance.
UEs that perform better than the minimum requirements can benefit from higher data rates as the network does not make too conservative scheduling assumptions.
UE vendors do not need to provide or indicate any implementation details to the network to optimize scheduling decisions for better performing UEs. In this regard, it should be considered that UE may consider its different implementation aspects and design into account when evaluating (prevailing signal and operating) conditions in view of whether it can support flexible duplex operations and with what parameters. For instance, according to at least some examples of embodiments, the UE knows whether a self-interference cancellation algorithm is implemented in the given device and thus, the UE can better support duplex operations even in more challenging conditions like with higher Tx power, larger UL RB allocation size and/or smaller frequency difference between UL and DL transmission. In view of still further implementation aspects to be considered by the UE according to various examples of embodiments, UL/DL radio front end and antenna isolations may be band and/or frequency dependent and, hence, UE design specific. Alternatively and/or additionally, the UE considering its different implementation aspects may further comprise the UE taking into account at least one of the following: a form factor of the UE, like e.g. the UE being a laptop, since a laptop generally has e.g. better isolation capabilities as compared to e.g. a smartphone, and other implementation aspects like e.g. the sensitivity of the receiver, the type of (radio) cell and/or the distance to an access node.
L1 or MAC based signaling indication from the UE to the network has short delays and, therefore, the network has very up-to-date information on what kind of flexible duplex related parameters and configurations the UE can currently support in current, i.e. prevailing conditions. This allows for more accurate scheduling decisions at the gNB and, thus, enables enhanced throughputs for the UE and more efficient and flexible network flexible duplex operations.

It shall be noted that the present specification may be considered for both flexible duplex operation with UL and DL resources on non-overlapping frequency resources and for full duplex operation with partial and fully overlapping frequency resources.

In the following, further examples of embodiments are described in relation to the above described methods and/or apparatuses.

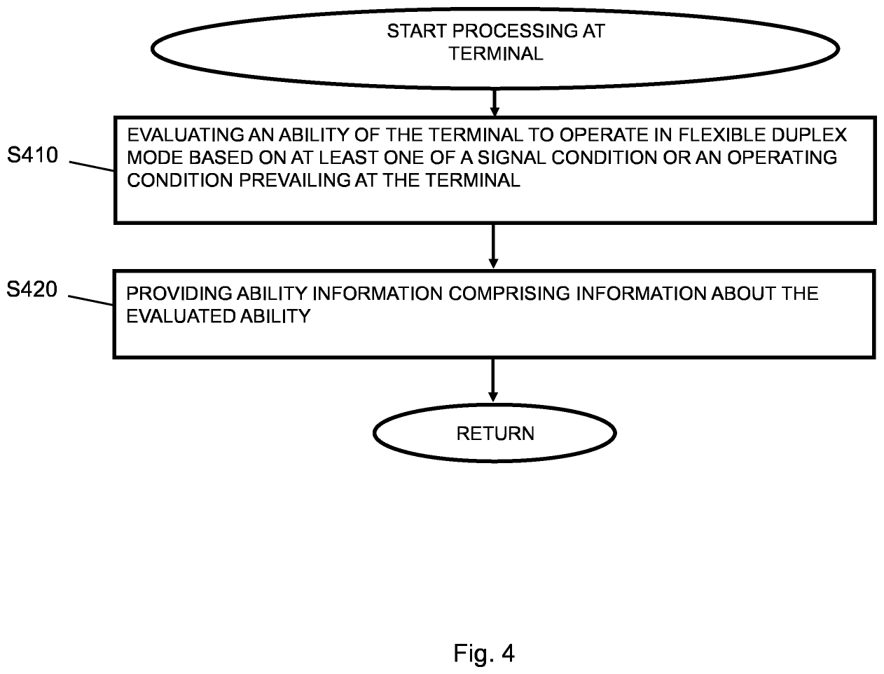

Referring now to FIG. 4, there is shown a flowchart illustrating steps corresponding to a method according to various examples of embodiments. Such processing as illustrated with reference to FIG. 4 may represent and/or correspond to at least part of such processing as illustrated with reference to FIGS. 2 and 3. Moreover, such terminal as described with reference to FIG. 4 may comprise such UE as outlined above with reference to FIGS. 1 to 3.

In particular, according to FIG. 4, in S410, the method comprises evaluating, at a terminal, an ability of the terminal to operate in flexible duplex mode based on at least one of a signal condition or an operating condition prevailing at the terminal.

It shall be noted that such evaluating may comprise and/or represent such evaluating as outlined above with reference to steps S220 and S320 in combination with FIGS. 2 and 3.

It shall further be noted that such at least one of signal condition or operating condition may comprise at least one of the terminal's transmit, Tx, power, an uplink resource block allocation size, a frequency offset between downlink and uplink resource blocks, a performance of the terminal's receiver, the terminal's self-interference mitigation performance or the terminal's ability to perform self-interference cancellation, the terminal's tolerance to self-interference, the terminal's ability to change downlink modulation and coding scheme, MCS, due to flexible duplex operations, or an indication of how much guard band in terms of frequency is needed between UL and DL signal.

It shall further be noted that the terminal may have received a trigger to perform such evaluation from a network access element, which may represent e.g. such gNB as outlined above with reference to FIGS. 1 to 3 or from a network management entity, like e.g. an access and mobility management function, AMF, or a session management function, SMF. Alternatively and/or additionally, the terminal may be associated with a group of terminals and may have received such trigger from another terminal of said group. However, the terminal is not necessarily limited thereto. Rather, the terminal may perform such evaluation within predetermined time intervals and/or at predetermined time points. In an embodiment, the terminal may receive such configuration or at least part of such configuration from a network access element, which may represent e.g. such gNB as outlined above with reference to FIGS. 1 to 3, or from a network management entity, like e.g. an access and mobility management function, AMF, or a session management function, SMF. Alternatively and/or additionally, the terminal may be associated with a group of terminals and may receive such configuration or at least part of such configuration from another terminal of said group.

Further, in S420, the method comprises providing ability information comprising information about the terminal's evaluated ability.

It shall be noted that such ability information may be provided to a network entity, which may have triggered the above-outlined evaluating in step S410. However, the providing of the ability information is not necessarily limited thereto. Rather, providing to e.g. a network management entity may (additionally and/or alternatively) be performed.

It shall further be noted that providing may be understood as transmitting. Further, providing may also be understood in that the ability information are made available to be acquired by an (authorized) network entity.

Alternatively and/or additionally, such providing may be performed by use of signaling and/or dynamic signaling. Moreover, it shall be noted that such dynamic signaling may correspond to such dynamic signaling as outlined above with reference to e.g. FIGS. 2 and 3, as well as Tables 1 and 2.

Hence, according to at least some examples of embodiments, it shall be noted that the terminal may need to evaluate and then (based on a result obtained from a potentially optional deciding step performed at the terminal about whether or not a signaling from the terminal to the network is to be performed) signal (e.g. report) to the network what key configurations and parameter values it (i.e. the terminal) can support for its flexible duplex operations in given, i.e. prevailing radio and interference conditions, with network and system parameters (like e.g. carrier frequency, bandwidth, SCS) and with a given device implementation that the terminal may know by itself.

In view thereof, the signaling from the terminal to the network may be optimized by not sending all the key parameters but by sending instead an index to e.g. a table indicating what is the maximum Tx power, what is the minimum frequency difference/offset between DL and UL resource blocks for currently used SCS, and/or what is the maximum uplink resource block size that the terminal can support for flexible duplex operations with the current, i.e. prevailing network and system parameters, like e.g. subcarrier spacing, carrier frequency, system BW, and in given (e.g. prevailing) radio and interference conditions and with the terminal's own implementation assumption.

Moreover, according to at least some examples of embodiments, the evaluating may comprise detecting the at least one of prevailing signal condition or prevailing operating condition and evaluating the ability of the terminal to operate in flexible duplex mode further based on the at least one of detected prevailing signal condition or detected prevailing operating condition, and the information about the terminal's evaluated ability may be indicative of the at least one of detected prevailing signal condition or detected prevailing operating condition.

Furthermore, according to various examples of embodiments, the method may further comprise obtaining at least one flexible duplex parameter; and evaluating the ability of the terminal to operate in flexible duplex mode further based on the obtained at least one flexible duplex parameter.

It shall further be noted that such at least one flexible duplex parameter may correspond to such key parameters as outlined above with reference to FIGS. 1 to 3. Moreover, the obtained at least one flexible duplex parameter may comprise at least one of the terminal's transmit, Tx, power, an uplink resource block allocation size, a frequency offset between downlink and uplink resource blocks, a performance of the terminal's receiver, the terminal's self-interference mitigation performance or the terminal's ability to perform self-interference cancellation, the terminal's tolerance to self-interference, the terminal's ability to change downlink modulation and coding scheme, MCS, due to flexible duplex operations, or an indication of how much guard band in terms of frequency is needed between UL and DL signal.

Hence, it shall be noted that according to at least some examples of embodiments, the obtained at least one flexible duplex parameter may correspond to a condition comprised by the at least one of signal condition or operating condition. Thus, it shall be understood that the terminal may be triggered, based on an obtained flexible duplex parameter, to consider a specific signal or operating condition, the specific signal or operating condition corresponding to the obtained flexible duplex parameter.

Further, according to various examples of embodiments, the method may further comprise at least one of: receiving a flexible duplex ability evaluation configuration, wherein the flexible duplex ability evaluation configuration is indicative of the at least one flexible duplex parameter, or obtaining the at least one flexible duplex parameter by acquiring the at least one flexible duplex parameter based on the terminal's specification.

It shall be noted that such flexible duplex ability evaluation configuration may comprise and/or represent such configuration as outlined above with reference to e.g. FIGS. 2 and 3 as well as steps S210, S220, S310 and S320.

It shall further be noted that the terminal may receive such configuration from such gNB as outlined above with reference to FIGS. 1 to 3. However, the terminal is not necessarily limited thereto. Rather, the terminal may receive such configuration or at least part of such configuration from a network access element, which may represent e.g. such gNB as outlined above with reference to FIGS. 1 to 3, or from a network management entity, like e.g. an access and mobility management function, AMF, or a session management function, SMF. Alternatively and/or additionally, the terminal may be associated with a group of terminals and may receive such configuration or at least part of such configuration from another terminal of said group.

Alternatively and/or additionally, it shall still further be noted that the terminal may obtain such configuration or at least part thereof by acquiring such configuration or at least part thereof directly from the specification. I.e., the configuration or at least part thereof may be defined based on present, existing, and/or applied implementation specification (like e.g. a configuration or at least part thereof as specified in e.g. one of the 3GPP specifications). Accordingly, a potential further part of the configuration may be received from the network (as outlined above in detail).

Furthermore, according to various examples of embodiments, based on a result resulting from the evaluating, the information about the terminal's evaluated ability may be indicative of a flexible duplex configuration supportable by the terminal and/or a scheduling decision supportable by the terminal, or an indication about the terminal not being capable to support operation in flexible duplex mode.

Additionally, according to various examples of embodiments, if the terminal's evaluated ability may exceed a predetermined minimum ability level, the information about the terminal's evaluated ability may be indicative of an indication that a demand exceeding the predetermined minimum ability level is supportable by the terminal.

Furthermore, according to various examples of embodiments, the providing may comprise using signaling based on at least one of Layer 1, L1, reporting, Medium Access Control-control element, MAC-CE, based reporting, Radio Resource Control, RRC, signaling based event-triggered reporting, or periodical terminal reporting.

It shall be noted that the providing may correspond to such transmitting/sending as outlined above with reference to FIGS. 2 and 3 as well as steps S220 and S330.

Additionally, according to various examples of embodiments, a signaling and/or a dynamic signaling based on the L1 reporting may be configured to be periodical or aperiodical.

Optionally, according to at least some examples of embodiments, the signaling based on the MAC-CE based reporting may be triggered if at least one of an amount of change in the terminal's Tx power is more than a predetermined threshold change value, the terminal's Tx power exceeds or falls below a predetermined threshold power value, an uplink resource block allocation size changes, an uplink resource block frequency offset changes, a periodic timer or prohibit timer expires, or an terminal's internal condition, comprising at least one of a temperature or a battery level, changes.

Further, according to various examples of embodiments, the signaling may comprise indicating at least one flexible duplex index related to the ability of the terminal to operate in flexible duplex mode, wherein the at least one flexible duplex index may be an index out of a plurality of predetermined flexible duplex indexes each related to a respective combination of predetermined signal conditions and/or predetermined operating conditions.

Moreover, according to at least some examples of embodiments, the plurality of predetermined flexible duplex indexes may be numbered consecutively, and the indicating of the at least one flexible duplex index having a certain number further comprises may indicate the terminal's prevailing flexible duplex support for flexible duplex indexes having a number lower than the certain number.

Furthermore, according to various examples of embodiments, if the terminal has not yet entered flexible duplex operation, the method may further comprise learning from previously performed flexible duplex operations at signal conditions and/or operating conditions similar to the at least one of prevailing signal condition or prevailing operating condition, and evaluating the ability of the terminal to operate in flexible duplex mode further based on a learning result from the learning.

Further, according to various examples of embodiments, the method may further comprise deciding, prior to the providing, whether or not to provide the ability information, based on if the terminal's evaluated ability has changed from a previous terminal's evaluated ability.

It shall be noted that such change may represent such change and/or sufficient change as outlined above. I.e. such change may comprise that a change from previously evaluated and/or previously detected prevailing conditions may have been evaluated and/or detected (with e.g. no effect on the flexible duplex operations to be supported by the terminal). It may further comprise that such change from previously evaluated and/or previously detected prevailing conditions may also lead to a change (i.e. increase, decrease and/or variation) in the flexible duplex operations to be supported by the terminal.

The above-outlined solution allow for flexible duplex signaling for indicating duplex support. Therefore, the above-outlined solution, to be performed at a terminal, is advantageous in that it enables for flexible duplex signaling for indicating duplex support. Hence, at least part of the advantages as outlined above in detail with reference to FIGS. 2 and 3 are achieved.

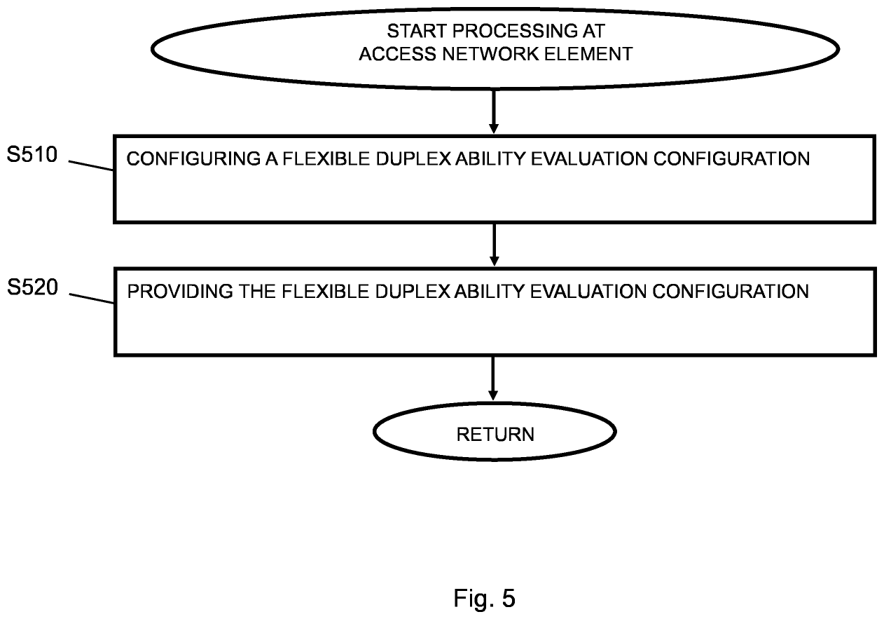

Referring now to FIG. 5, FIG. 5 shows a flowchart illustrating steps corresponding to a method according to various examples of embodiments.

Such processing as illustrated with reference to FIG. 5 may represent and/or correspond to at least part of such processing as illustrated with reference to FIGS. 2 and 3. Moreover, such access network element as described with reference to FIG. 5 may comprise such gNB as outlined above with reference to FIGS. 1 to 3. Moreover, such terminal as described with reference to FIG. 5 may comprise such UE as outlined above with reference to FIGS. 1 to 3 and/or such terminal as described with reference to FIG. 4.

In particular, according to FIG. 5, in S510, the method comprises configuring, at an access network element, a flexible duplex ability evaluation configuration.

It shall be noted that the flexible duplex ability evaluation configuration enables a terminal to evaluate the terminal's ability to operate in flexible duplex mode based on at least one of a signal condition or an operating condition prevailing at the terminal. Examples for the at least one of signal condition or operating condition are outlined-above with reference to e.g. FIG. 4.

It shall further be noted that the configuring may correspond to such configuring as outlined above with reference to FIGS. 2 and 3 as well as steps S210, S220, S310 and S320.

In step S520, the method comprises providing the flexible duplex ability evaluation configuration.

It shall be noted that providing may be understood as transmitting. Further, providing may also be understood in that the flexible duplex ability evaluation configuration is made available to be acquired by an (authorized) network entity.

It shall further be noted that such flexible duplex ability evaluation configuration may be provided, i.e. transmitted from the access network element to a terminal.

Further, according to various examples of embodiments, the configuring may be performed periodically, aperiodically or represents a one-time configuration.

Moreover, according to at least some examples of embodiments, the configuring may further comprise configuring at least one flexible duplex parameter; and the providing may further comprise providing the configured at least one flexible duplex parameter, wherein the flexible duplex ability evaluation configuration may further enable the terminal to evaluate the ability of the terminal to operate in flexible duplex mode based on the configured at least one flexible duplex parameter.

Furthermore, according to various examples of embodiments, the method may further comprise receiving ability information based on the provided flexible duplex ability evaluation configuration, the ability information comprising information about the terminal's evaluated ability, and performing at least one of the following based on the received ability information: configuring the terminal to use or not to use flexible duplex, or scheduling the terminal.

It shall be noted that the performing may correspond to such step S230 and/or step S340 as outlined above with reference to FIGS. 2 and 3.

Optionally, according to at least some examples of embodiments, the method may further comprise acquiring, whether or not the terminal is in flexible duplex operation, and if the terminal has not yet entered flexible duplex operation, buffering the received ability information.

It shall be noted that the received ability information may be buffered to be updated after the terminal has entered flexible duplex operation.

In an embodiment, the UE may determine/evaluate the key parameters and information which are indicative of associated flexible duplex abilities during the current operating/signaling conditions. The UE may, if the determined key parameters and information are indicative of a changed flexible duplex ability, inform the network about the changed flexible duplex ability. This may be performed by the UE transmitting an indication of the key parameters and information, e.g. in the form of one or more indexes (as outlined in Tables above). The transmitting may be e.g. L1, MAC CE or RRC signaling. In this way the gNB acquires knowledge that it can e.g. schedule the UE with more freedom than if the UE would be assumed to merely fulfil the minimum flexible duplex ability. The scheduling may comprise e.g. allocating more data to the UE than would be possible assuming merely minimum flexible duplex abilities. As said above, the key parameters to be evaluated by the UE may be provided to the UE by the gNB in form of a configuration. The key parameters may comprise e.g. one or more of: UE transmit power level, frequency offset between downlink and uplink resource blocks, ability cancel or cope with self-interference, or UL RB allocation size. The current operating/signaling conditions may affect these, as e.g. if the propagation loss, multipath delays, etc. are severe, then the key parameters may require an adjustment.

The above-outlined solution allow for flexible duplex signaling for indicating duplex support. Therefore, the above-outlined solution, to be performed at an access network element, is advantageous in that it enables for flexible duplex signaling for indicating duplex support. Hence, at least part of the advantages as outlined above in detail with reference to FIGS. 2 and 3 are achieved.

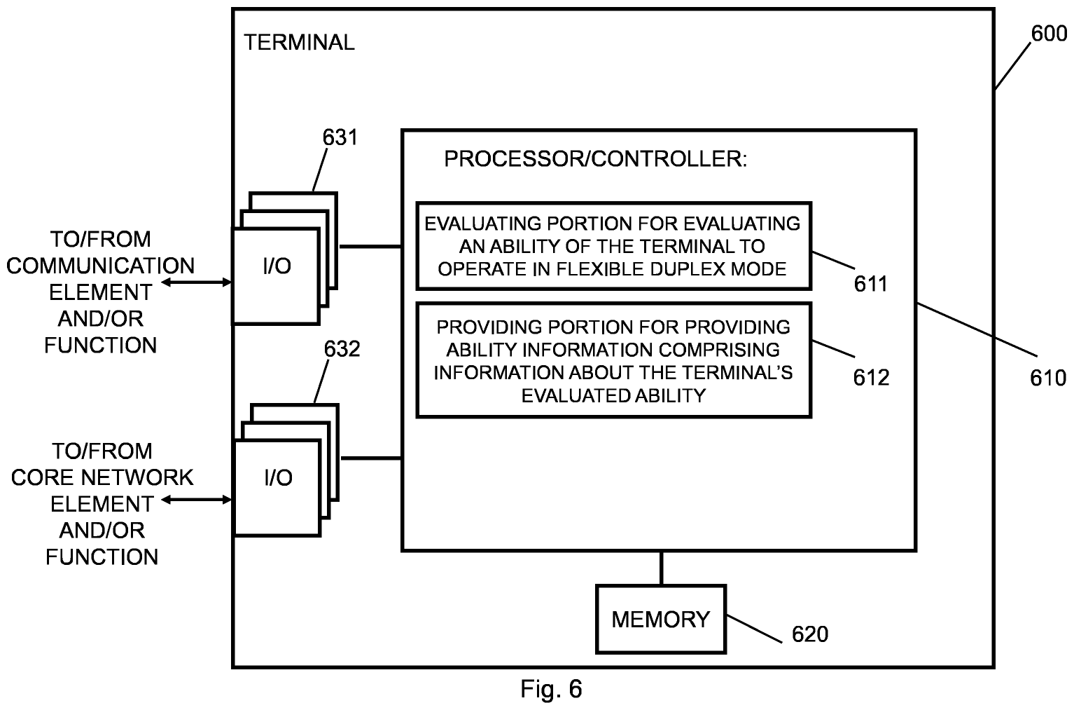

Referring now to FIG. 6, FIG. 6 shows a block diagram illustrating an apparatus according to various examples of embodiments.

Specifically, FIG. 6 shows a block diagram illustrating an apparatus 600, which may be such UE as outlined above with reference to FIGS. 1 to 3 and/or such terminal as outlined above with reference to FIGS. 4 and 5, according to various examples of embodiments, which may participate in flexible duplex signaling for indicating duplex support. Furthermore, even though reference is made to a terminal, the terminal may be also another device or function having a similar task, such as a chipset, a chip, a module, an application etc., which can also be part of a network element or attached as a separate element to a network element, or the like. It should be understood that each block and any combination thereof may be implemented by various means or their combinations, such as hardware, software, firmware, one or more processors and/or circuitry.

The apparatus 600 shown in FIG. 6 may include a processing circuitry, a processing function, a control unit or a processor 610, such as a CPU or the like, which is suitable to enable flexible duplex signaling for indicating duplex support. The processor 610 may include one or more processing portions or functions dedicated to specific processing as described below, or the processing may be run in a single processor or processing function. Portions for executing such specific processing may be also provided as discrete elements or within one or more further processors, processing functions or processing portions, such as in one physical processor like a CPU or in one or more physical or virtual entities, for example. Reference signs 631 and 632 denote input/output (I/O) units or functions (interfaces) connected to the processor or processing function 610. The I/O units 631 and 632 may be a combined unit including communication equipment towards several entities/elements, or may include a distributed structure with a plurality of different interfaces for different entities/elements. Reference sign 620 denotes a memory usable, for example, for storing data and programs to be executed by the processor or processing function 610 and/or as a working storage of the processor or processing function 610. It is to be noted that the memory 620 may be implemented by using one or more memory portions of the same or different type of memory, but may also represent an external memory, e.g. an external database provided on a cloud server.

The processor or processing function 610 is configured to execute processing related to the above described processing. In particular, the processor or processing circuitry or function 610 includes one or more of the following sub-portions. Sub-portion 611 is an evaluating portion for evaluating an ability of the terminal to operate in flexible duplex mode. The portion 611 may be configured to perform processing according to S410 of FIG. 4. Moreover, sub-portion 612 is a providing portion for providing ability information comprising information about the terminal's evaluated ability. The portion 612 may be configured to perform processing according to S420 of FIG. 4.

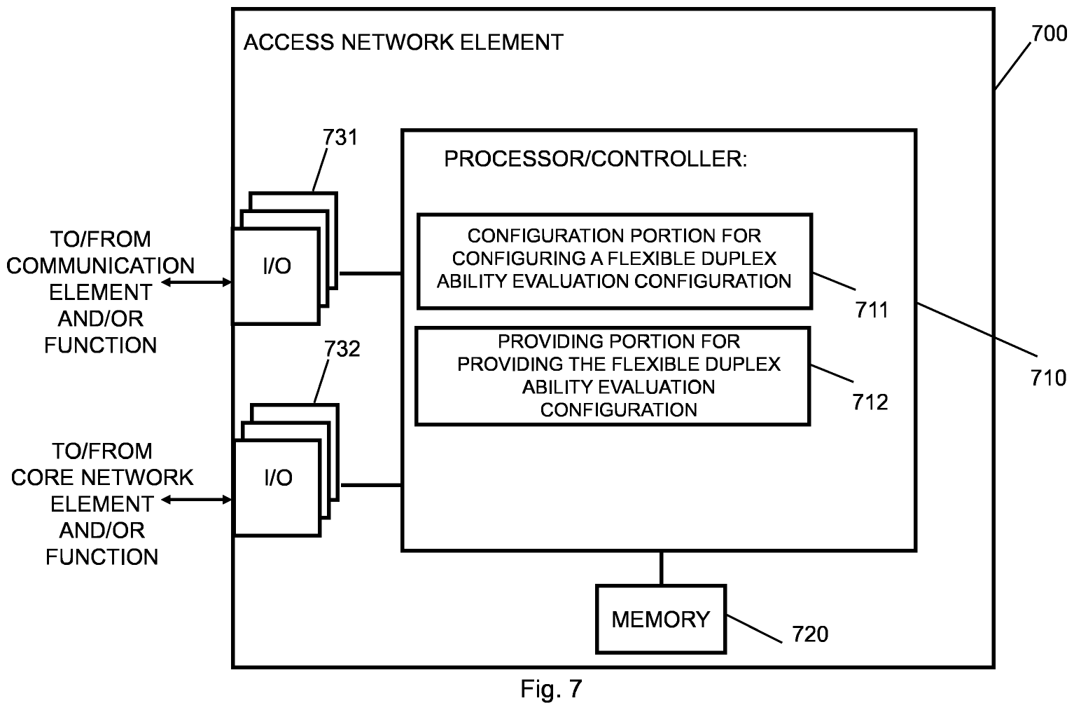

Referring now to FIG. 7, FIG. 7 shows a block diagram illustrating an apparatus according to various examples of embodiments.

Specifically, FIG. 7 shows a block diagram illustrating an apparatus, which may represent such gNB as outlined above with reference to FIGS. 1 to 3 and/or such network access element as outlined above with reference to FIG. 5, according to various examples of embodiments, which may participate in in flexible duplex signaling for indicating duplex support. Furthermore, even though reference is made to an access network element, the access network element may be also another device or function having a similar task, such as a chipset, a chip, a module, an application etc., which can also be part of a network element or attached as a separate element to a network element, or the like. It should be understood that each block and any combination thereof may be implemented by various means or their combinations, such as hardware, software, firmware, one or more processors and/or circuitry.

The apparatus 700 shown in FIG. 7 may include a processing circuitry, a processing function, a control unit or a processor 710, such as a CPU or the like, which is suitable to enable flexible duplex signaling for indicating duplex support. The processor 710 may include one or more processing portions or functions dedicated to specific processing as described below, or the processing may be run in a single processor or processing function. Portions for executing such specific processing may be also provided as discrete elements or within one or more further processors, processing functions or processing portions, such as in one physical processor like a CPU or in one or more physical or virtual entities, for example. Reference signs 731 and 732 denote input/output (I/O) units or functions (interfaces) connected to the processor or processing function 710. The I/O units 731 and 732 may be a combined unit including communication equipment towards several entities/elements, or may include a distributed structure with a plurality of different interfaces for different entities/elements. Reference sign 720 denotes a memory usable, for example, for storing data and programs to be executed by the processor or processing function 710 and/or as a working storage of the processor or processing function 710. It is to be noted that the memory 720 may be implemented by using one or more memory portions of the same or different type of memory, but may also represent an external memory, e.g. an external database provided on a cloud server.

The processor or processing function 710 is configured to execute processing related to the above described processing. In particular, the processor or processing circuitry or function 710 includes one or more of the following sub-portions. Sub-portion 711 is a configuration portion for configuring a flexible duplex ability evaluation configuration. The portion 711 may be configured to perform processing according to S510 of FIG. 5. Further, sub-portion 712 is a providing portion for providing the flexible duplex ability evaluation configuration. The portion 712 may be configured to perform processing according to S520 of FIG. 5.

It shall be noted that the apparatuses 600 and 700 as outlined above with reference to FIGS. 6 and 7 may comprise further/additional sub-portions, which may allow the apparatuses 600 and 700 to perform such methods/method steps as outlined above with reference to FIGS. 2 and 3.

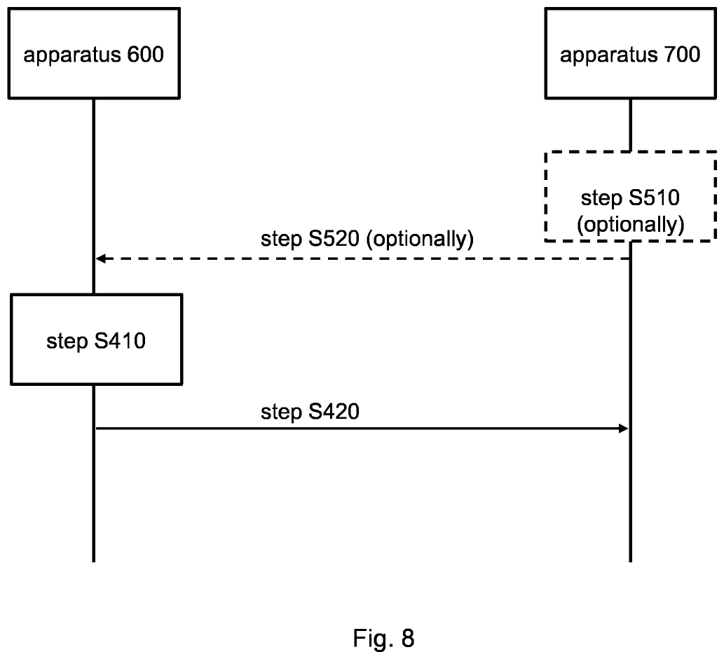

Referring now to FIG. 8, FIG. 8 shows a diagram illustrating signaling flows according to various examples of embodiments.

In particular, FIG. 8 shows an example for one potential interaction of at least several potential interactions between apparatus 600 as outlined above with reference to FIG. 6 and apparatus 700 as outlined above with reference to FIG. 7.

Optionally, the apparatus 700 may perform the steps S510 and S520 as outlined above with reference to FIG. 5. Accordingly, a configured flexible duplex ability evaluation configuration may be transmitted to the apparatus 600 and the apparatus 600 may receive such configuration. Further, the apparatus 700 may perform the steps S410 and S420 as outlined above with reference to FIG. 4. Accordingly, ability information comprising information about the apparatus's 600 evaluated ability to operate in flexible duplex mode are evaluated and a resulting evaluation result is transmitted to the apparatus 700. Such transmission may be performed by use of signaling and/or dynamic signaling.

It should be appreciated that
an access technology via which traffic is transferred to and from an entity in the communication network may be any suitable present or future technology, such as WLAN (Wireless Local Access Network), WiMAX (Worldwide Interoperability for Microwave Access), LTE, LTE-A, 5G, 6G, Bluetooth, Infrared, and the like may be used; additionally, embodiments may also apply wired technologies, e.g. IP based access technologies like cable networks or fixed lines.
embodiments suitable to be implemented as software code or portions of it and being run using a processor or processing function are software code independent and can be specified using any known or future developed programming language, such as a high-level programming language, such as objective-C, C, C++, C#, Java, Python, Javascript, other scripting languages etc., or a low-level programming language, such as a machine language, or an assembler.
implementation of embodiments is hardware independent and may be implemented using any known or future developed hardware technology or any hybrids of these, such as a microprocessor or CPU (Central Processing Unit), MOS (Metal Oxide Semiconductor), CMOS (Complementary MOS), BiMOS (Bipolar MOS), BiCMOS (Bipolar CMOS), ECL (Emitter Coupled Logic), and/or TTL (Transistor-Transistor Logic).
embodiments may be implemented as individual devices, apparatuses, units, means or functions, or in a distributed fashion, for example, one or more processors or processing functions may be used or shared in the processing, or one or more processing sections or processing portions may be used and shared in the processing, wherein one physical processor or more than one physical processor may be used for implementing one or more processing portions dedicated to specific processing as described,
an apparatus may be implemented by a semiconductor chip, a chipset, or a (hardware) module including such chip or chipset;
embodiments may also be implemented as any combination of hardware and software, such as ASIC (Application Specific IC (Integrated Circuit)) components, FPGA (Field-programmable Gate Arrays) or CPLD (Complex Programmable Logic Device) components or DSP (Digital Signal Processor) components.
embodiments may also be implemented as computer program products, including a computer usable medium having a computer readable program code embodied therein, the computer readable program code adapted to execute a process as described in embodiments, wherein the computer usable medium may be a non-transitory medium.

Although the present disclosure has been described herein before with reference to particular embodiments thereof, the present disclosure is not limited thereto and various modifications can be made thereto.

1.-38. (canceled)

39. An apparatus, comprising:
at least one processor; and
at least one memory storing instructions that, when executed by the at least one processor, cause the apparatus at least to:
obtain flexible duplex parameters comprising: a terminal's transmit (Tx) power, an uplink resource block allocation size, a frequency offset between downlink and uplink resource blocks, a performance of the terminal's receiver, the terminal's self-interference mitigation performance or the terminal's ability to perform self-interference cancellation, the terminal's tolerance to self-interference, the terminal's ability to change downlink modulation and coding scheme (MCS) due to flexible duplex operations, and an indication of how much guard band in terms of frequency is needed between uplink (UL) and downlink (DL) signal;
evaluate an ability of the apparatus to operate in flexible duplex mode based on the flexible duplex parameters and a signal condition or an operating condition prevailing at the apparatus;
based on an evaluation result of the evaluation, generate ability information about the apparatus's evaluated ability, the information comprising:
a flexible duplex configuration supportable by the apparatus;
a scheduling decision supportable by the apparatus; and
an indication about the apparatus not being capable to support operation in flexible duplex mode;
provide the ability information by use of signaling being based on Medium Access Control-control element (MAC-CE) based, wherein the signaling based on the MAC-CE based reporting is triggered when following occur: an amount of change in a Tx power of the apparatus is more than a predetermined threshold change value, a Tx power of the apparatus exceeds or falls below a predetermined threshold power value, an UL resource block allocation size changes, an UL resource block frequency offset changes, a prohibit timer expires, and an internal temperature changes; and
provide by use of the signaling, at least one flexible duplex index related to the ability of the apparatus to operate in flexible duplex mode, wherein the at least one flexible duplex index is an index out of a plurality of predetermined flexible duplex indexes each related to a respective combination of predetermined signal conditions and predetermined operating conditions, the plurality of predetermined flexible duplex indexes being numbered consecutively; and
indicate, in the signaling, the at least one flexible duplex index having a certain number further comprises the apparatus's indication for prevailing flexible duplex support for flexible duplex indexes having a number lower than the certain number.

40. The apparatus according to claim 39, wherein the apparatus caused to evaluate the ability of the apparatus to operate in flexible duplex mode is further caused to detect the at least one of prevailing signal condition or prevailing operating condition and to evaluate the ability of the apparatus to operate in flexible duplex mode further based on the at least one of detected prevailing signal condition or detected prevailing operating condition, and
the information about the apparatus's evaluated ability is indicative of the at least one of detected prevailing signal condition or detected prevailing operating condition.

41. The apparatus according to claim 40, wherein the apparatus is further caused to:
receive a flexible duplex ability evaluation configuration, wherein the flexible duplex ability evaluation configuration is indicative of the flexible duplex parameters.

42. The apparatus according to claim 41, wherein the apparatus is further caused to:
obtain the at flexible duplex parameters by acquiring the flexible duplex parameters based on a specification of the apparatus.

43. The apparatus according to claim 42, wherein when the apparatus's evaluated ability exceeds a predetermined minimum ability level, the information about the apparatus's evaluated ability is indicative of an indication that a demand exceeding the predetermined minimum ability level is supportable by the apparatus.

44. The apparatus according to claim 43, wherein the apparatus is further caused to,
when the apparatus has not yet entered flexible duplex operation:
learn from previously performed flexible duplex operations at signal conditions and operating conditions similar to the at least one of prevailing signal condition and prevailing operating condition; and
evaluate the ability of the apparatus to operate in flexible duplex mode further based on a learning result from the learning.

45. The apparatus according to claim 44, wherein the apparatus is further caused to:
decide, prior to provide the ability information, whether or not to provide the ability information, based on if the apparatus's evaluated ability has changed from a previous apparatus's evaluated ability.

46. A system comprising:
an apparatus;
at least one processor; and
at least one memory storing instructions that, when executed by the at least one processor, cause the apparatus at least to:
obtain flexible duplex parameters comprising: a terminal's transmit (Tx) power, an uplink resource block allocation size, a frequency offset between downlink and uplink resource blocks, a performance of the terminal's receiver, the terminal's self-interference mitigation performance or the terminal's ability to perform self-interference cancellation, the terminal's tolerance to self-interference, the terminal's ability to change downlink modulation and coding scheme (MCS) due to flexible duplex operations, and an indication of how much guard band in terms of frequency is needed between uplink (UL) and downlink (DL) signal;
evaluate an ability of the apparatus to operate in flexible duplex mode based on the flexible duplex parameters and a signal condition or an operating condition prevailing at the apparatus;
based on an evaluation result of the evaluation, generate ability information about the apparatus's evaluated ability, the information comprising:
a flexible duplex configuration supportable by the apparatus;
a scheduling decision supportable by the apparatus; and
an indication about the apparatus not being capable to support operation in flexible duplex mode;
provide the ability information by use of signaling being based on Medium Access Control-control element (MAC-CE) based, wherein the signaling based on the MAC-CE based reporting is triggered when following occur: an amount of change in a Tx power of the apparatus is more than a predetermined threshold change value, a Tx power of the apparatus exceeds or falls below a predetermined threshold power value, an UL resource block allocation size changes, an UL resource block frequency offset changes, a prohibit timer expires, and an internal temperature changes; and
provide by use of the signaling, at least one flexible duplex index related to the ability of the apparatus to operate in flexible duplex mode, wherein the at least one flexible duplex index is an index out of a plurality of predetermined flexible duplex indexes each related to a respective combination of predetermined signal conditions and predetermined operating conditions, the plurality of predetermined flexible duplex indexes being numbered consecutively; and
indicate, in the signaling, the at least one flexible duplex index having a certain number further comprises the apparatus's indication for prevailing flexible duplex support for flexible duplex indexes having a number lower than the certain number.

47. The system according to claim 46, wherein the apparatus caused to evaluate the ability of the apparatus to operate in flexible duplex mode is further caused to detect the at least one of prevailing signal condition or prevailing operating condition and to evaluate the ability of the apparatus to operate in flexible duplex mode further based on the at least one of detected prevailing signal condition or detected prevailing operating condition, and
the information about the apparatus's evaluated ability is indicative of the at least one of detected prevailing signal condition or detected prevailing operating condition.

48. The system according to claim 47, wherein the apparatus is further caused to:
receive a flexible duplex ability evaluation configuration, wherein the flexible duplex ability evaluation configuration is indicative of the flexible duplex parameters.

49. The system according to claim 48, wherein the apparatus is further caused to:
obtain the at flexible duplex parameters by acquiring the flexible duplex parameters based on a specification of the apparatus.

50. The system according to claim 49, wherein when the apparatus's evaluated ability exceeds a predetermined minimum ability level, the information about the apparatus's evaluated ability is indicative of an indication that a demand exceeding the predetermined minimum ability level is supportable by the apparatus.

51. The system according to claim 50, wherein the apparatus is further caused to,
when the apparatus has not yet entered flexible duplex operation:
learn from previously performed flexible duplex operations at signal conditions and operating conditions similar to the at least one of prevailing signal condition and prevailing operating condition; and
evaluate the ability of the apparatus to operate in flexible duplex mode further based on a learning result from the learning.

52. The system according to claim 51, wherein the apparatus is further caused to:
decide, prior to provide the ability information, whether or not to provide the ability information, based on if the apparatus's evaluated ability has changed from a previous apparatus's evaluated ability.

53. A method comprising:
obtaining, by an apparatus, flexible duplex parameters comprising: a terminal's transmit (Tx) power, an uplink resource block allocation size, a frequency offset between downlink and uplink resource blocks, a performance of the terminal's receiver, the terminal's self-interference mitigation performance or the terminal's ability to perform self-interference cancellation, the terminal's tolerance to self-interference, the terminal's ability to change downlink modulation and coding scheme (MCS) due to flexible duplex operations, and an indication of how much guard band in terms of frequency is needed between uplink (UL) and downlink (DL) signal;
evaluating an ability of the apparatus to operate in flexible duplex mode based on the flexible duplex parameters and a signal condition or an operating condition prevailing at the apparatus;
based on an evaluation result of the evaluation, generating ability information about the apparatus's evaluated ability, the information comprising:
a flexible duplex configuration supportable by the apparatus;
a scheduling decision supportable by the apparatus; and
an indication about the apparatus not being capable to support operation in flexible duplex mode;
providing the ability information by use of signaling being based on Medium Access Control-control element (MAC-CE) based, wherein the signaling based on the MAC-CE based reporting is triggered when following occur: an amount of change in a Tx power of the apparatus is more than a predetermined threshold change value, a Tx power of the apparatus exceeds or falls below a predetermined threshold power value, an UL resource block allocation size changes, an UL resource block frequency offset changes, a prohibit timer expires, and an internal temperature changes; and
providing by use of the signaling, at least one flexible duplex index related to the ability of the apparatus to operate in flexible duplex mode, wherein the at least one flexible duplex index is an index out of a plurality of predetermined flexible duplex indexes each related to a respective combination of predetermined signal conditions and predetermined operating conditions, the plurality of predetermined flexible duplex indexes being numbered consecutively; and
indicating, in the signaling, the at least one flexible duplex index having a certain number further comprises the apparatus's indication for prevailing flexible duplex support for flexible duplex indexes having a number lower than the certain number.

54. The system according to claim 53, wherein the apparatus caused to evaluate the ability of the apparatus to operate in flexible duplex mode is further caused to detect the at least one of prevailing signal condition or prevailing operating condition and to evaluate the ability of the apparatus to operate in flexible duplex mode further based on the at least one of detected prevailing signal condition or detected prevailing operating condition, and
the information about the apparatus's evaluated ability is indicative of the at least one of detected prevailing signal condition or detected prevailing operating condition.

55. The method according to claim 54, further comprising: receiving a flexible duplex ability evaluation configuration, wherein the flexible duplex ability evaluation configuration is indicative of the flexible duplex parameters.

56. The method according to claim 55, further comprising:
obtaining the at flexible duplex parameters by acquiring the flexible duplex parameters based on a specification of the apparatus.

57. The method according to claim 56, wherein when the apparatus's evaluated ability exceeds a predetermined minimum ability level, the information about the apparatus's evaluated ability is indicative of an indication that a demand exceeding the predetermined minimum ability level is supportable by the apparatus.

58. The method according to claim 57, further comprising:
when the apparatus has not yet entered flexible duplex operation:
learn from previously performed flexible duplex operations at signal conditions and operating conditions similar to the at least one of prevailing signal condition and prevailing operating condition; and
evaluate the ability of the apparatus to operate in flexible duplex mode further based on a learning result from the learning.
